(19) United States
(12) Patent Application Publication
(10) Pub. No.: US 2025/0368293 A1
(43) Pub. Date: Dec. 4, 2025

(54) POWER ASSISTED BICYCLE

(71) Applicant: Panasonic Intellectual Property Management Co., Ltd., Osaka (JP)

(72) Inventors: Nobuhito KAKUKI, Osaka (JP); Masaya YOSHIMURA, Osaka (JP); Takanori NAKANO, Nara (JP); Hiroshi FUJITA, Osaka (JP); Koji KATAO, Osaka (JP)

(73) Assignee: Panasonic Intellectual Property Management Co., Ltd., Osaka (JP)

(21) Appl. No.: 18/876,415

(22) PCT Filed: Oct. 6, 2023
(86) PCT No.: PCT/JP2023/036536

§ 371 Date: Dec. 18, 2024

(30) Foreign Application Priority Data
Oct. 28, 2022 (JP) 2022-173201

(51) Int. Cl. B62M 6/45

(52) U.S. Cl. CPC B62M 6/45

(57) ABSTRACT

A power assisted bicycle, which is one example of an embodiment, is provided with a braking device that imparts braking force for suppressing backward movement of the body of the bicycle when a predetermined braking condition is met, a control device, and a push-walking operation unit. The braking condition under which the braking device operates includes at least one selected from, for example, an uphill slope being detected and the bicycle being detected to be moving backwards, after operation of the push-walking operation unit has ended.

### TECHNICAL FIELD

The present invention relates to an electric assist bicycle.

### BACKGROUND ART

Conventionally, electric assist bicycles that assist human driving force from pedaling with motor power have been widely known. In addition, an electric assist bicycle having a function to assist push-walking with the bicycle has been proposed (refer to Patent Literature 1, for example). The electric assist bicycle disclosed in Patent Literature 1 comprises a control device capable of executing a first mode in which a motor does not apply torque to wheels, a second mode in which the motor applies stay auxiliary torque to the wheels, and a third mode in which the motor applies push-walking auxiliary torque to the wheels. The electric assist bicycle is configured to allow selection of each mode based on a user operation.

### CITATION LIST

### Patent Literature

PATENT LITERATURE 1: Japanese Unexamined Patent Application Publication No. 2017-100541

### SUMMARY

According to the electric assist bicycle disclosed in Patent Literature 1, during push-walking with the bicycle, it is possible to easily keep the bicycle in place by selecting the above-described second mode through operation of an operation unit. However, with the electric assist bicycle, in a case where backward movement of the bicycle that is unintended by a user has occurred, the backward movement cannot be quickly prevented in some cases. For example, it is difficult to quickly prevent backward movement of the bicycle in a case where a finger accidentally slips off an operation unit for generating push-walking auxiliary power during push-walking with the bicycle on an upslope.

It is an advantage of the present invention to quickly prevent backward movement of a bicycle that is unintended by a user.

An electric assist bicycle as an aspect of the present invention comprises: a riding device; an electric motor; a control unit configured to execute, in a switching manner, a first mode in which first auxiliary driving force from the electric motor is added to human driving force based on pedal stepping force for traveling, and a second mode in which second auxiliary driving force from the electric motor is added to pushing force on a vehicle body for push-walking or the second auxiliary driving force is added for self-propelling the electric assist bicycle; a riding device state detection unit configured to detect a state of the riding device, the state including a first state in which the riding device is rideable and a second state in which the riding device is not rideable; a second mode operation unit configured to transmit a signal for executing the second mode to the control unit; and a braking device configured to apply braking force to prevent backward movement of the electric assist bicycle in a case where a braking condition is met, wherein the control unit executes the second mode in a case where the second mode operation unit is operated in the second state, and the braking condition includes at least one of a first braking condition where an upslope is detected in the second state and a second braking condition where backward movement of the electric assist bicycle is detected in the second state.

An electric assist bicycle as another aspect of the present invention comprises: an electric motor; a control unit configured to execute, in a switching manner, a first mode in which first auxiliary driving force from the electric motor is added to human driving force based on pedal stepping force for traveling, and a second mode in which second auxiliary driving force from the electric motor is added to pushing force on a vehicle body for push-walking or the second auxiliary driving force is added for self-propelling the electric assist bicycle; a second mode operation unit configured to transmit a signal for executing the second mode to the control unit; and a braking device configured to apply braking force to prevent backward movement of the electric assist bicycle in a case where a braking condition is met, and the braking condition includes at least one of a first braking condition where an upslope is detected after an operation of the second mode operation unit ends and a second braking condition where backward movement of the electric assist bicycle is detected after an operation of the second mode operation unit ends.

An electric assist bicycle as another aspect of the present invention comprises: an electric motor; a control unit configured to execute an electric assist mode in which auxiliary driving force from the electric motor is added to human driving force based on pedal stepping force for traveling; and a braking device configured to apply braking force to prevent backward movement of the electric assist bicycle in a case where a braking condition is met, and the braking condition includes at least one of a first braking condition where an upslope is detected in a case of stopping after traveling at or above a predetermined speed and a second braking condition where backward movement of the electric assist bicycle is detected within a predetermined time in a case of stopping after traveling at or above a predetermined speed.

With an electric assist bicycle according to the present invention, it is possible to quickly prevent backward movement of the bicycle that is unintended by a user. With the electric assist bicycle according to the present invention, for example, in a case where backward movement of the bicycle is detected, a braking device is automatically activated and applies braking force to prevent backward movement of the bicycle.

### BRIEF DESCRIPTION OF DRAWING

FIG. 1 is a side view of an electric assist bicycle as an example of an embodiment, illustrating a first state in which the electric assist bicycle is rideable.

FIG. 2 is a side view of the electric assist bicycle, illustrating a second state in which the electric assist bicycle is not rideable.

FIG. 3 is a diagram illustrating a switching unit in a case where a saddle is in the first state.

FIG. 4 is a diagram illustrating the switching unit in a case where the saddle is in the second state.

FIG. 5 is a diagram illustrating a handlebar of the electric assist bicycle and its vicinity.

FIG. 6 is a block diagram illustrating a basic configuration of the electric assist bicycle.

FIG. 7 is a block diagram illustrating a specific example of the configuration of the electric assist bicycle.

FIG. 8 is a diagram illustrating an example of state transition of the electric assist bicycle.

FIG. 9 is a diagram illustrating another example of state transition of the electric assist bicycle.

FIG. 10 is a flowchart illustrating an example of a basic control procedure related to backward movement prevention of the electric assist bicycle.

FIG. 11 is a flowchart illustrating a specific example of a control procedure related to backward movement prevention of the electric assist bicycle.

### DESCRIPTION OF EMBODIMENTS

An embodiment of an electric assist bicycle according to the present invention will be described below in detail with reference to the accompanying drawings. The embodiment described below is merely exemplary, and the present invention is not limited to the embodiment below. Any form of selective combination of a plurality of embodiments and modifications described below is included in the present invention.

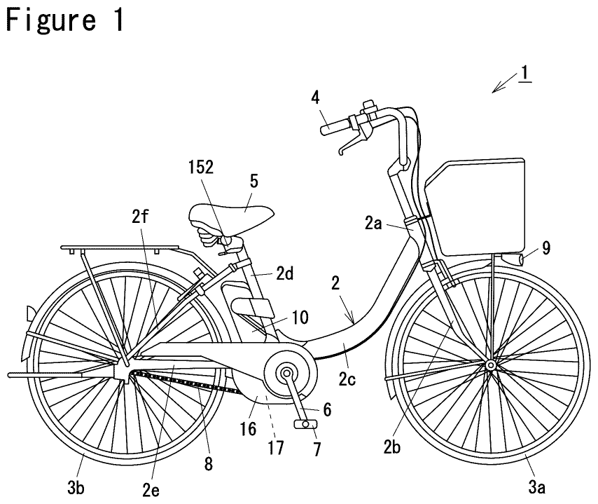

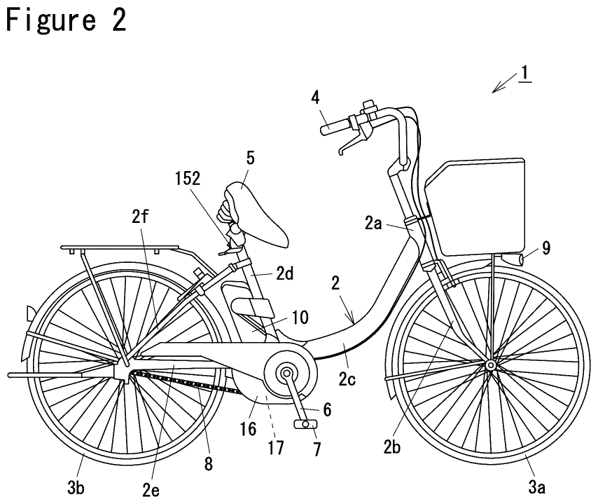

FIGS. 1 and 2 are side views of an electric assist bicycle 1 as an example of the embodiment. FIG. 1 illustrates a first state in which the bicycle is rideable, and FIG. 2 illustrates a second state in which the bicycle is not rideable. For the purpose of description, terms for description of front, back, up, down, right, and left directions are used in the following description, and the front, back, up, down, right, and left directions of the electric assist bicycle 1 and its constituent components mean front, back, up, down, right, and left directions in a normal use state. The front direction is the proceeding direction of the electric assist bicycle 1 when traveling.

As illustrated in FIGS. 1 and 2, the electric assist bicycle 1 comprises a motor unit 16 including an electric motor 17. The electric assist bicycle 1 comprises a battery 10, and the electric motor 17 drives with electric power supplied from the battery 10. The electric assist bicycle 1 further comprises a braking device 12 and a control device 20.

The braking device 12 applies braking force to prevent backward movement of a vehicle body in a case where a braking condition is met. The control device 20 is a control unit configured to execute, in a switching manner, a first mode in which first auxiliary driving force from the electric motor 17 is added to human driving force based on stepping force on a pedal 7 for traveling, and a second mode in which second auxiliary driving force from the electric motor 17 is added to pushing force on the vehicle body for push-walking or the second auxiliary driving force is added for self-propelling the electric assist bicycle.

The above-described first mode is a mode in which the first auxiliary driving force from the electric motor 17 is added to human driving force based on stepping force on the pedal 7 for traveling, and is typically called an assist travel mode. The above-described second mode is a mode in which the second auxiliary driving force from the electric motor 17 is added to pushing force on the vehicle body for push-walking or the second auxiliary driving force is added for self-propelling the electric assist bicycle. The second mode includes a push-walking mode and a self-propelling mode. In the push-walking mode, when a user walks while pushing the electric assist bicycle 1, the second auxiliary driving force is added based on force of the user that pushes the vehicle body forward, thereby assisting forward movement of the vehicle body. In the self-propelling mode, the second auxiliary driving force is added to assist forward movement in the case of the vehicle body is supported without pushing the vehicle body forward.

Hereinafter, the first mode is also referred to as the “assist travel mode”, and the second mode is also referred to as the “push-walking mode”. As described later in detail, the push-walking mode of the present embodiment includes a push-walking drive mode in which power that assists push-walking with the vehicle body is applied to the wheels, a push-walking stay mode in which braking force is applied to the wheels by functions of the braking device 12, and a free mode in which push-walking auxiliary power and braking force are not applied. In the electric assist bicycle 1, transition from the free mode to the push-walking stay mode is automatically executed without an operation by the user. Thus, it is possible to quickly prevent backward movement of the bicycle that is unintended by the user during push-walking of the bicycle.

Similarly to a typical bicycle, the electric assist bicycle 1 comprises a frame 2, the wheels (a front wheel 3a and a rear wheel 3b), a handlebar 4, a saddle 5, a crank arm 6, the pedal 7, a chain 8, and a headlamp 9. The crank arm 6 and the pedal 7 attached to one end part thereof are provided on each of the right and left sides of the electric assist bicycle 1, and the other end parts of the pair of crank arms 6 are coupled by a crankshaft.

The electric assist bicycle 1 comprises a front sprocket that rotates along with rotation of the pedal 7, and a rear wheel sprocket provided at the rear wheel 3b, and the front sprocket and the rear wheel sprocket are coupled through the chain 8. In the present embodiment, stepping force on the pedal 7 and auxiliary power from the electric motor 17 are transferred to the rear wheel 3b through the chain 8. Note that the motor unit 16 may be a single-axis type in which rotational force of the electric motor 17 is transferred to the front sprocket through a reduction gear and the like, or may be a dual-axis type in which rotational force of the electric motor 17 is transferred to an auxiliary power output sprocket engaged with the chain 8 through a reduction gear and the like.

The frame 2 is a structure that couples the front wheel 3a, the rear wheel 3b, the handlebar 4, the saddle 5, and other components. The frame 2 is constituted by a plurality of pipes and supports the battery 10 and the motor unit 16. In the present embodiment, a head pipe 2a, a front fork 2b, a down pipe 2c, a seat pipe 2d, a chain stay 2e, a seat stay 2f, and a bottom bracket are provided as the plurality of pipes. The bottom bracket is a pipe connecting the down pipe 2c, the seat pipe 2d, and the chain stay 2e.

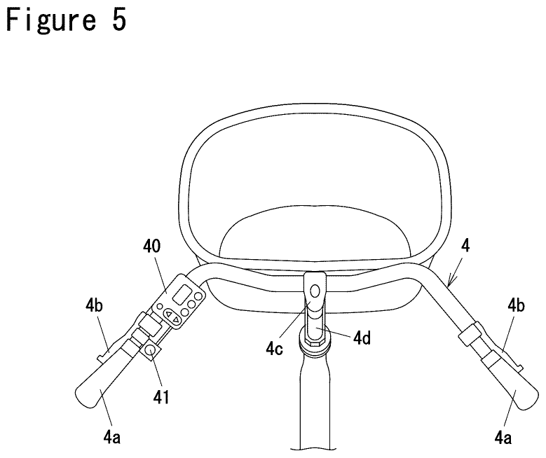

The head pipe 2a supports the front fork 2b and the handlebar 4 in a manner rotatable about the central axis of the pipe. The front fork 2b includes a pair of legs supporting the front wheel 3a in a rotatable manner, and a steering column 4d (refer to FIG. 5) extending upward from upper end parts of the legs and inserted into the tube of the head pipe 2a. The handlebar 4 is attached to an upper end part of the steering column 4d. The down pipe 2c is a pipe connecting the head pipe 2a and the seat pipe 2d. The seat pipe 2d is a pipe supporting the saddle 5.

The chain stay 2e is a pipe connecting the seat stay 2f and the bottom bracket, extends from a back end part of the bottom bracket to the back side of the bicycle, and is provided on each of the right and left sides to sandwich the rear wheel 3b in between. Similarly to the chain stay 2e, the seat stay 2f is provided on each of the right and left sides to sandwich the rear wheel 3b in between. The right and left seat stays 2f extend from an upper part of the seat pipe 2d to a central part of the rear wheel 3b in the radial direction and are coupled to the right and left chain stays 2e in one-to-one relation at the central part. The rear wheel 3b is rotatably fixed to back parts of the chain stays 2e.

The electric assist bicycle 1 comprises a riding device. In the present embodiment, the riding device is constituted by the saddle 5 and a switching unit 152 supporting the saddle 5. The saddle 5 is fixed to the seat pipe 2d through the switching unit 152. The switching unit 152 switches the state of the saddle 5 between the first state (refer to FIG. 1) in which the bicycle is rideable at a legitimate position where a seat surface of the saddle 5 faces upward and the second state (refer to FIG. 2) at an illegitimate position where the seat surface of the saddle 5 faces forward. The saddle 5 in the second state is in a state in which the back of the saddle 5 is lifted up further than the front end and the user cannot sit on it, in other words, a state in which the bicycle is not rideable.

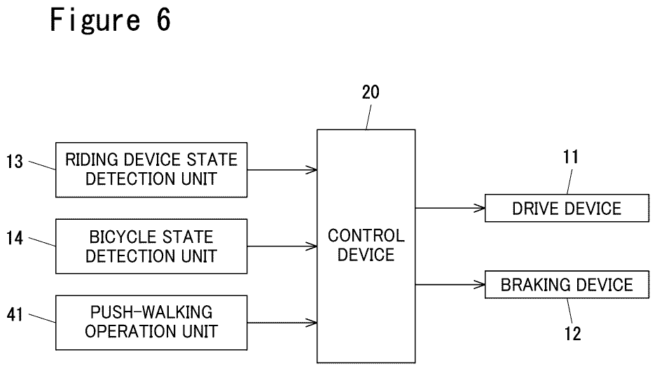

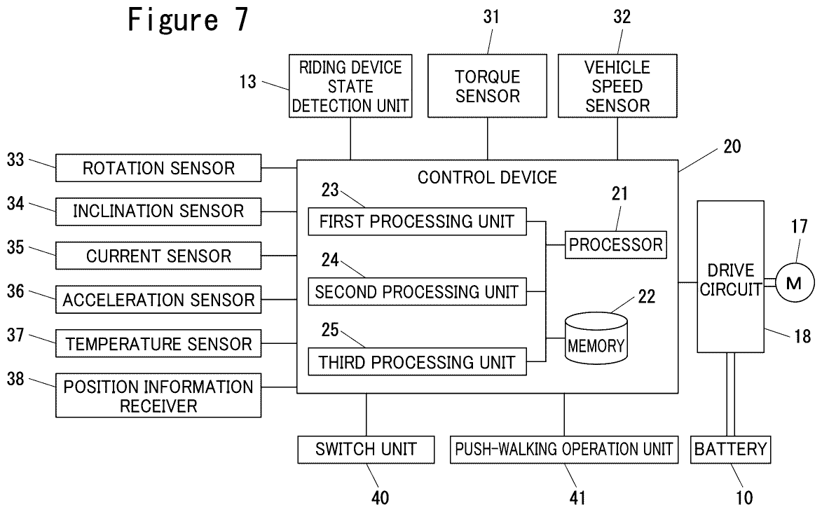

The switching unit 152 is provided with a riding device state detection unit 13 (refer to FIGS. 6 and 7 to be described later) configured to detect the state of the riding device. As described later in detail, a braking condition where the braking device 12 is activated includes at least one of a first braking condition where an upslope is detected in a case where the riding device is in the second state where the bicycle is not rideable, and a second braking condition where backward movement of the bicycle is detected in the second state. The control device 20 may activate the braking device 12 on at least one of a condition where the bicycle is positioned on an upslope in a case where an operation of a push-walking operation unit 41 (refer to FIG. 5 to be described later) ends in the second state and a condition where the bicycle is moved backward.

The above-described first braking condition may be such that an upslope is detected in a case where the electric assist bicycle 1 has stopped after traveling at or above a predetermined speed. For example, backward movement of the bicycle that is unintended by the user is likely to occur in a case where the electric assist bicycle 1 has stopped on an upslope after traveling in the assist travel mode, and thus in such a case, the backward movement can be quickly prevented by activating the braking device 12. In this case, the control device 20 may activate the braking device 12 irrespective of whether the user is riding on the bicycle and irrespective of whether the bicycle has moved backward. The condition where the bicycle is positioned on an upslope may be detected by, for example, an inclination sensing device to be described later. The control device 20 may activate the braking device 12 in a case where an upward inclination degree greater than or equal to a predetermined degree is sensed by the inclination sensing device.

The above-described second braking condition may be such that backward movement of the bicycle is detected within a predetermined time in a case where the electric assist bicycle 1 has stopped after traveling at or above a predetermined speed. The predetermined time is set to be, for example, a time shorter than or equal to one second. For example, in a case where backward movement is detected within the predetermined time after the electric assist bicycle 1 travels in the assist travel mode, the backward movement is potentially unintended by the user. Note that, in this case, the bicycle is highly likely to be positioned on an upslope. The control device 20 may activate the braking device 12 in a case where backward movement of the bicycle is detected irrespective of whether the bicycle is positioned on an upslope. Alternatively, the control device 20 may activate the braking device 12 in a case where the bicycle is positioned on an upslope and has moved backward.

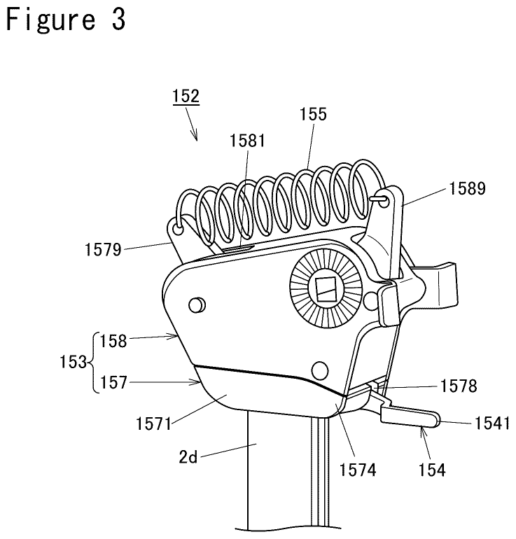

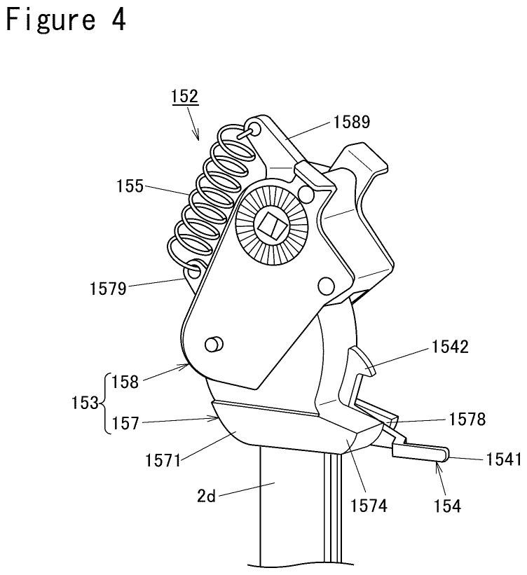

FIG. 3 is a perspective view illustrating the switching unit 152 in a case where the saddle 5 is in the first state. FIG. 4 is a perspective view illustrating the switching unit 152 in a case where the saddle 5 is in the second state.

As illustrated in FIGS. 3 and 4, the switching unit 152 comprises a base section 153, a lever section 154, and a pressing section 155. The base section 153 is a part supporting the saddle 5 in a freely movable manner and includes a base part 157 and a movable base 158. The base part 157 is a metal member integrally comprising a body part 1571 freely rotatable supporting the movable base 158, and a shaft (not illustrated) projecting from a lower part of the body part 1571 and inserted into the seat pipe 2d. The movable base 158 is pivotally supported in a rotatable manner about a shaft parallel to the right-left direction on the front end side of the body part 1571. The saddle 5 is fixed to the movable base 158 so that the saddle 5 operates following operation of the movable base 158.

A first support 1579 is provided on the front end side of the body part 1571. One end part of the pressing section 155 is coupled to the first support 1579. A projecting portion 1574 projecting backward is provided on the back side of the body part 1571. In the projecting portion 1574, a slit 1578 that guides the lever section 154 is formed in the front-back direction. The lever section 154 is pivotally supported on the body part 1571 in a rotatable manner in a state of being disposed in the slit 1578. In addition, a slit 1581 through which the first support 1579 penetrates is formed on the front end side of the movable base 158. As the movable base 158 rotates, the first support 1579 relatively moves in the slit 1581 and the front end of the movable base 158 contacts the front end of the body part 1571, and accordingly, rotation of the movable base 158 is regulated.

A second support 1589 erected upward is provided on the back side of the movable base 158. The other end part of the pressing section 155 is coupled to a distal end part of the second support 1589. The pressing section 155 is, for example, a spring such as a coil spring. The pressing section 155 applies, to the first support 1579 and the second support 1589, pressing force in a direction in which the first support 1579 and the second support 1589 approach each other. In other words, the pressing section 155 applies pressing force in a direction in which the saddle 5 changes to the second state.

The lever section 154 is pivotally supported on the body part 1571 in a rotatable manner. One end side of the lever section 154 is a grip section 1541 and protrudes backward from the slit 1578 of the body part 1571. A claw section 1542 extending upward is formed on the other end side of the lever section 154. The claw section 1542 regulates rotation of the movable base 158 by engaging with the movable base 158. Accordingly, the saddle 5 is maintained in the first state. When the grip section 1541 is operated by the user, the lever section 154 rotates and the claw section 1542 disengages from the movable base 158. Accordingly, the movable base 158 rotates by pressing force of the pressing section 155 and the saddle 5 changes to the second state.

The switching unit 152 is provided with the riding device state detection unit 13 configured to detect the state of the saddle 5. The riding device state detection unit 13 is fixed in a recessed part (not illustrated) formed in the body part 1571. The recessed part is formed in a groove shape extending in the up-down direction from an upper part of the body part 1571. The movable base 158 has an arm section (not illustrated) extending in the recessed part. A magnet is fixed to a distal end part of the arm section. The arm section operates simultaneously with operation of the movable base 158, and thus the relative positional relation between the magnet and the riding device state detection unit 13 varies.

The riding device state detection unit 13 is, for example, a magnetic proximity sensor and outputs no detection signal when the magnet of the arm section is at a reference position (position when the saddle 5 is in the first state). The riding device state detection unit 13 outputs a detection signal when the saddle 5 is in the second state. In this manner, the riding device state detection unit 13 detects the second state of the saddle 5 by detecting the position of the magnet of the arm section that operates simultaneously with motion of the movable base 158.

FIG. 5 is an enlarged view of the handlebar 4 and its vicinity.

As illustrated in FIG. 5, a grip 4a and a brake lever 4b are attached to each end part of the handlebar 4. In addition, the steering column 4d is coupled to a central part of the handlebar 4 through a stem 4c. The handlebar 4 is a raised-type handlebar where the grips 4a are positioned higher than the stem 4c. The handlebar 4 has a substantially U shape when viewed from the top, its right and left end parts extend to the back side of the bicycle, and the interval between the end parts increases such that the handlebar 4 is positioned closer to the outside of the bicycle as the position approaches the right and left ends.

The grips 4a are parts that the user grips during traveling and push-walking with the electric assist bicycle 1. The brake levers 4b are operation sections for activating brakes attached to the wheels. Typically, the brake lever 4b on the left side is an operation section for brake of the rear wheel 3b, and the brake lever 4b on the right side is an operation section for brake of the front wheel 3a. In a case where backward movement of the bicycle that is unintended by the user has occurred during push-walking, the backward movement can be prevented by operating the brake levers 4b, but a quick lever operation is difficult in some cases. The electric assist bicycle 1 automatically transitions to the above-described push-walking stay mode and braking force is applied to the wheels by functions of the braking device 12, and thus backward movement of the vehicle body in such a case can be quickly prevented.

A switch unit 40 and the push-walking operation unit 41 are attached to the handlebar 4. The switch unit 40 is typically called a handlebar switch and is attached near the left grip 4a of the handlebar 4. In the present embodiment, the push-walking operation unit 41 is provided between the switch unit 40 and the grip 4a. The push-walking operation unit 41 is connected to the switch unit 40 through a cable, but does not necessarily need to be connected to the switch unit 40, or may be integrated with the switch unit 40. Note that the structure of attachment of the switch unit 40 and the push-walking operation unit 41 to the handlebar 4 is not particularly limited.

The switch unit 40 includes, for example, a power switch, an assist switching switch, a headlamp switch, and a display unit. The power switch is an operation section for activating the control device 20. When the power switch is turned on, the assist travel mode and the push-walking mode are executed. The assist switching switch includes, for example, an “UP” button and a “DOWN” button for adjusting the ratio of auxiliary power from the electric motor 17 relative to human driving force. The display unit is, for example, a liquid crystal monitor. The display unit may display, for example, a battery remaining amount, the bicycle operation mode, and time.

The push-walking operation unit 41 is a second mode operation unit for executing the push-walking mode (second mode) and is operated by the user. Thus, the push-walking operation unit 41 is disposed near the grip 4a so that the push-walking operation unit 41 can be easily operated during push-walking. The push-walking operation unit 41 transmits a signal for executing the second mode to the control device 20 based on an operation by the user. The form of the push-walking operation unit 41 is not particularly limited, but in the present embodiment, a push-button switch is used as the push-walking operation unit 41. The push-walking operation unit 41 is, for example, a momentary switch configured to output an operation signal while being pushed by the user. When the push-walking operation unit 41 is not operated by pushing, no signal is output and the second mode is not executed.

FIG. 6 is a block diagram illustrating a basic configuration of the electric assist bicycle 1 related to the push-walking mode (second mode).

As illustrated in FIG. 6, the electric assist bicycle 1 comprises a drive device 11, the braking device 12, the riding device state detection unit 13, a bicycle state detection unit 14, and the push-walking operation unit 41. The electric assist bicycle 1 also comprises the control device 20 configured to control the drive device 11 and the braking device 12. The control device 20 acquires detection information from each detection unit and controls the drive device 11 and the braking device 12 based on the detection information. When having received an operation signal from the push-walking operation unit 41, the control device 20 executes the push-walking mode in which the second auxiliary driving force is output from the drive device 11. In the present embodiment, while a button of the push-walking operation unit 41 is pushed by a finger, switch elements constituting the push-walking operation unit 41 are connected at a contact point and the operation signal is output.

The drive device 11 is an electric motor configured to output push-walking auxiliary power and may be a different motor to a motor used in the assist travel mode, but the same electric motor 17 is preferably used in the assist travel mode and the push-walking mode. The electric motor 17 (drive device 11) only needs to be an electric motor capable of driving with electric power supplied from the battery 10 and causing the electric assist bicycle 1 to travel, but is a three-phase brushless DC motor as a preferable example.

The braking device 12 is a device configured to apply braking force to the wheels and automatically activated under control of the control device 20 when a predetermined braking condition is met. The braking device 12 may be an electrically-controlled brake, an electromagnetic brake, or the like, but the electric motor 17 is preferably used as the braking device 12 from the perspectives of cost reduction, vehicle weight reduction, and the like. Examples of braking methods in this case include regenerative braking and short-circuit braking. In the present embodiment, braking force is applied to the rear wheel 3b.

The riding device state detection unit 13 is configured to be able to detect whether the saddle 5 is in a state in which sitting is possible. In the present embodiment, a detection signal is output from the riding device state detection unit 13 in a case where the saddle 5 is in the second state in which sitting is not possible. Transition to the push-walking mode is permitted only in the second state. In this case, the control device 20 transitions the operation mode of the bicycle to the push-walking mode in a case where the second state is detected by the riding device state detection unit 13 and the push-walking operation unit 41 is operated. In a case where the saddle 5 is in the first state, an operation of the push-walking operation unit 41 is disabled.

In the present embodiment, transition is made from the free mode to the push-walking drive mode when the push-walking operation unit 41 is operated by pushing, and the push-walking drive mode is continued while the pushing operation is performed, in other words, while the operation signal is output. When the pushing operation of the push-walking operation unit 41 stops, the operation mode of the bicycle transitions from the push-walking drive mode to the free mode and further transitions to the push-walking stay mode in a case where a predetermined braking condition where the braking device 12 is activated is met.

The bicycle state detection unit 14 is configured to be able to detect the state of the electric assist bicycle 1. With functions of the bicycle state detection unit 14, it is detected, for example, whether the state of the electric assist bicycle 1 is in a state where a predetermined braking condition is met. As described later in detail, an existing sensor mounted on a conventionally well-known electric assist bicycle may be applied to the bicycle state detection unit 14.

In the present embodiment, the braking condition includes at least one of the first braking condition where an upslope is detected and the second braking condition where backward movement of the bicycle is detected, both after an operation of the push-walking operation unit 41 ends. The braking condition may be such that the bicycle is positioned on an upslope and backward movement of the bicycle is detected after an operation of the push-walking operation unit 41 ends. Transition is made to the push-walking stay mode when the braking condition is met, but in the present embodiment, since transition to the push-walking mode is permitted only in the second state, it can be said that the braking condition includes a condition where the riding device is in the second state.

FIG. 7 is a block diagram illustrating a specific example of the configuration of the electric assist bicycle 1. Hereinafter, with reference to a specific example of each above-described detection unit, more detailed description will be made on a specific example of the configuration of the electric assist bicycle 1 related to the push-walking mode, in particular.

As illustrated in FIG. 7, the control device 20 is connected to various sensors, operation units, a drive circuit 18 of the electric motor 17, and the like. The control device 20 is constituted by a microcomputer comprising, for example, a processor 21, a memory 22, and an input-output interface. The control device 20 includes a first processing unit 23 configured to execute the assist travel mode, a second processing unit 24 configured to execute the push-walking drive mode, and a third processing unit 25 configured to execute the push-walking stay mode.

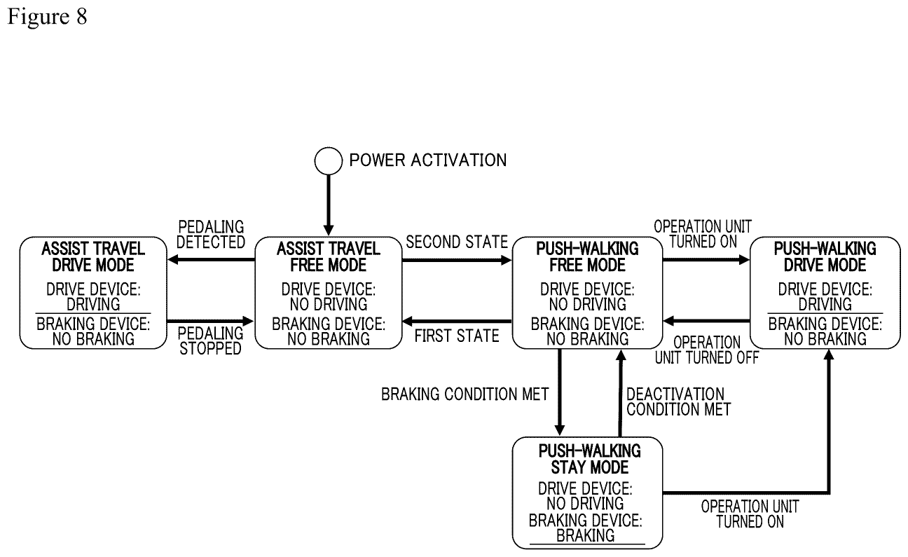

The push-walking mode of the present embodiment includes the push-walking drive mode, the push-walking stay mode, and a push-walking free mode (refer to FIG. 8 to be described later), and the control device 20 is configured to execute the three operation modes. The operation mode of the bicycle transitions from the push-walking drive mode to the push-walking stay mode through the push-walking free mode.

The processor 21 achieves functions of each above-described processing unit by reading and executing a control program. The memory 22 includes a non-transitory memory such as a ROM, an HDD, or an SSD, that stores the control program, various kinds of setting information, and the like, and a transitory memory such as a RAM. The control device 20 is typically built in the motor unit 16. Note that, in addition to the electric motor 17 and the control device 20, a deceleration mechanism, a one-way clutch, various sensors, the drive circuit 18, and the like are built in the motor unit 16.

The control device 20 is connected to the switch unit 40 and the push-walking operation unit 41 and configured to be able to receive the operation signal output from the push-walking operation unit 41 based on an operation by the user. The control device 20 controls the electric motor 17 based on an operation of the push-walking operation unit 41. Then, the second auxiliary driving force to assists push-walking with the bicycle is output. This function is executed by the second processing unit 24. However, in a case where the operation signal is received from the push-walking operation unit 41 but no detection information is received from the riding device state detection unit 13, the control device 20 does not execute the push-walking drive mode nor output the second auxiliary driving force. In other words, the control device 20 executes the push-walking mode in a case where the push-walking operation unit 41 is operated in the second state.

The electric assist bicycle 1 comprises a torque sensor 31 and a vehicle speed sensor 32. The torque sensor 31 is built in, for example, the motor unit 16 and detects a stepping force load acting on the crankshaft. The vehicle speed sensor 32 detects the vehicle speed based on the rotation speed of a wheel. The control device 20 is configured to control output of the electric motor 17 based on torque (stepping force load) acting on the crankshaft and the vehicle speed in the assist travel mode. This function is executed by the first processing unit 23. In the present embodiment, a control signal is output from the control device 20 to the drive circuit 18 and the drive circuit 18 performs switching operation based on the control signal, and accordingly, the amount of current supplied to the electric motor 17 changes. In this manner, output (motor torque) of the electric motor 17 is controlled.

The electric assist bicycle 1 may comprise at least one selected from among a rotation sensor 33, an inclination sensor 34, a current sensor 35, an acceleration sensor 36, and a temperature sensor 37. The electric assist bicycle 1 may also comprise a position information receiver 38 for acquiring position information of the bicycle. These sensors and the position information receiver 38 function as the bicycle state detection unit 14 used for determination of transition to the push-walking stay mode. In addition, the torque sensor 31 and the vehicle speed sensor 32 may be used as the bicycle state detection unit 14.

The rotation sensor 33 detects the rotation speed of the electric motor 17. As the electric assist bicycle 1 moves backward, the electric motor 17 rotates in a direction opposite that in the case of forward movement, and thus the backward movement of the bicycle can be detected by using the rotation sensor 33. The inclination sensor 34 is an inclination sensing device configured to detect the degree of inclination of the front-back direction of the bicycle relative to a horizontal state. Whether the electric assist bicycle 1 is positioned on an upslope, flat ground, or a downslope can be determined based on detection information from the inclination sensor 34. The current sensor 35 detects the amount of current supplied to the electric motor 17. The output level of the electric motor 17 can be determined based on detection information from the current sensor 35.

The acceleration sensor 36 detects, for example, the acceleration of the electric assist bicycle 1 in the front-back direction. The acceleration sensor 36 is set such that the acceleration when the bicycle moves forward is a positive value and the acceleration when the bicycle moves backward is a negative value. Motion of the bicycle in the front-back direction can be determined based on detection information from the acceleration sensor 36, and it can be determined that the bicycle is moving backward when the detected value of the acceleration sensor 36 is negative. The temperature sensor 37 detects, for example, the temperature of the electric motor 17. The temperature of the electric motor 17 can be used as a braking deactivation condition for stopping braking force application by the braking device 12. The temperature of the drive circuit 18 or the battery 10 may be detected by the temperature sensor 37 and used as the braking deactivation condition.

Note that conventionally well-known sensors may be applied as the rotation sensor 33, the inclination sensor 34, the current sensor 35, the acceleration sensor 36, and the temperature sensor 37. Moreover, the acceleration sensor 36 may be used as the inclination sensor 34.

The position information receiver 38 acquires position information of the electric assist bicycle 1 from a provider of position information, for example, an external server that provides position information. The position information receiver 38 may be a wireless communication module such as an LTE module or may be a short-distance communication module that communicates a communication terminal such as a smartphone owned by the user. For example, whether the bicycle is positioned on an upslope, flat ground, or a downslope can be determined based on the position information of the bicycle acquired by the position information receiver 38. The electric assist bicycle 1 may be configured to be able to acquire position information by the GPS. The position information receiver 38 may be able to acquire slope information of a place where the bicycle is positioned from an external server. Moreover, slope information of a road on which the bicycle travels may be stored in a storage device such as the memory 22.

The electric assist bicycle 1 preferably comprises a notification device for notifying that the braking device 12 is activated and braking force is applied. The notification device notifies the user that braking force is being applied on the wheels under control of the control device 20. Accordingly, the user can wait while braking force is applied or perform an operation to deactivate braking force, which improves usability. Note that the notification device may notify the surroundings that braking force is being applied.

The notification device only needs to be a device capable of notifying the user and its configuration is not particularly limited, but the notification device is preferably used as the switch unit 40. For example, the continuation time of the push-walking stay mode may be displayed on a monitor of the switch unit 40, and the time may be displayed as a countdown. The notification device (switch unit 40) may use sound or light to notify that braking force is being applied. Specifically, information of braking force application and its continuation time may be output by voice, and a lamp may be flashed while braking force is being applied.

As described above, the control device 20 is configured to activate the braking device 12 to prevent backward movement of the bicycle during push-walking in a case where the backward movement is checked based on detection information from the bicycle state detection unit 14. This function is executed by the third processing unit 25. In the present embodiment, the electric motor 17 is used as the braking device 12 and applies braking force to the rear wheel 3b by regenerative braking or short-circuit braking. In a case where braking force is generated by regenerative braking, generated electric power needs to be charged in the battery 10. Thus, regenerative braking and short-circuit braking may be switched in accordance with the charge level of the battery 10.

FIG. 8 is a diagram illustrating an example of state transition (operation mode transition) of the electric assist bicycle 1.

As illustrated in FIG. 8, when the power switch is turned on and the control device 20 is activated, the operation mode of the bicycle changes to an assist travel free mode in a case where the saddle 5 is in the first state, or senses an error and does not generate driving force by the electric motor 17 in a case where the saddle 5 is in the second state. After the error sensing, the operation mode changes to the assist travel free mode in a case where the saddle 5 changes to the first state. Note that the operation mode of the bicycle may change to the assist travel free mode irrespective of the state of the saddle 5 when the power switch is turned on and the control device 20 is activated. Alternatively, the destination of transition when the power switch is turned on and the control device 20 is activated may differ depending on the state of the saddle 5 as the riding device. In this case, the control device 20 transitions the operation mode of the bicycle to the assist travel free mode or the push-walking free mode based on the state of the saddle 5. The assist travel mode includes the assist travel free mode in which the electric motor 17 stops and no auxiliary power is generated and an assist travel drive mode in which the electric motor 17 is driven and auxiliary power is generated. The control device 20 can determine whether the saddle 5 is in the first state or the second state based on detection information from the riding device state detection unit 13.

The operation mode of the electric assist bicycle 1 transitions from the assist travel free mode to the assist travel drive mode when pedaling is detected. Specifically, transition is made to the assist travel drive mode when human driving force (stepping force load) generated by pedaling is detected by the torque sensor 31. Transition is made from the assist travel drive mode to the assist travel free mode when pedaling stops. Note that braking force of the braking device 12 is not generated in the assist travel mode.

In the example illustrated in FIG. 8, the operation mode of the bicycle does not transition from the assist travel mode to the push-walking mode in a case where the saddle 5 is in the first state. In addition, the operation mode of the bicycle does not transition from the push-walking mode to the assist travel mode in a case where the saddle 5 is in the second state.

While the operation signal is received from the push-walking operation unit 41, the control device 20 drives the electric motor 17 as the drive device 11 to generate the second auxiliary driving force that is push-walking auxiliary power. In this case, the operation mode of the electric assist bicycle 1 changes to the push-walking drive mode. Power of the electric motor 17 is applied to the rear wheel 3b and push-walking is assisted, which makes push-walking on an upslope easy. When the operation signal from the push-walking operation unit 41 stops, the control device 20 stops the electric motor 17 and the operation mode transitions from the push-walking drive mode to the push-walking free mode.

In the push-walking mode, the control device 20 automatically activates the braking device 12 in a case where the bicycle is positioned on an upslope after an operation of the push-walking operation unit 41 ends or in a case where backward movement of the bicycle is detected after an operation of the push-walking operation unit 41 ends. In this case, the operation mode of the electric assist bicycle 1 changes to the push-walking stay mode. The automatic activation of the braking device 12 means that the braking device 12 is activated to apply braking force based on determination by the control device 20 without an operation by the user. In the present embodiment, as described above, regenerative braking or short-circuit braking (hereinafter simply referred to as “braking” when these types do not need to be distinguished) is activated by using the electric motor 17.

The control device 20 determines backward movement of the bicycle based on, for example, detection information from the bicycle state detection unit 14 and activates braking in a case where backward movement for which braking force is to be applied has occurred. In the present embodiment, when the braking condition is met, transition is made from the push-walking drive mode to the push-walking stay mode through the push-walking free mode. In other words, transition is not made to the push-walking stay mode even when backward movement of the bicycle has occurred during an operation of the push-walking operation unit 41. Thus, it can be said that the control device 20 determines backward movement in the push-walking free mode.

The control device 20 may activate braking in a case where an upward inclination degree greater than or equal to a predetermined degree is sensed by the inclination sensor 34. Specifically, braking may be activated irrespective of backward movement in a case where the bicycle is positioned on an upslope with an inclination degree greater than or equal to the predetermined degree after an operation of the push-walking operation unit 41 ends. The upward inclination degree greater than or equal to the predetermined degree is set to be, for example, 6° or greater.

The control device 20 may determine that the braking condition is met and activate braking in a case where reverse rotation of the electric motor 17 is detected. Reverse rotation of the electric motor 17 can be detected by the rotation sensor 33. The control device 20 determines that backward movement of the bicycle has occurred and activates braking, for example, in a case where a detection signal indicating reverse rotation of the electric motor 17 is received by the rotation sensor 33. The control device 20 may activate braking in a case where a predetermined additional condition is met in addition to reverse rotation of the electric motor 17.

The control device 20 preferably activates braking only in a case where backward movement of the bicycle unintended by the user has occurred. Specifically, smooth backward movement is interfered or backward movement is difficult if braking is activated in a case where the user intentionally moves backward the bicycle, and thus braking force is preferably not applied in a case where the user intentionally performs backward movement. To achieve this function, when activating braking, the control device 20 determines whether the above-described predetermined additional condition is met in addition to information indicating backward movement of the bicycle such as reverse rotation of the electric motor 17.

The control device 20 determines that the braking condition (second braking condition) is met and activates braking, for example, in a case where reverse rotation of the electric motor 17 is detected and at least one condition selected from among a condition (1) in which a predetermined time or shorter has elapsed after the operation signal from the push-walking operation unit 41 stops, a condition (2) in which the bicycle is climbing a slope, a condition (3) in which the output of the electric motor 17 immediately before is greater than or equal to a predetermined value, a condition (4) in which the vehicle speed immediately before is less than or equal to a predetermined value, and a condition (5) in which the acceleration immediately before is less than or equal to a predetermined value is met. In this case, backward movement of the bicycle is checked based on reverse rotation of the electric motor 17 and whether the conditions (1) to (5) are met is determined, and thus only backward movement of the bicycle unintended by the user can be selectively prevented.

Braking force of the braking device 12 may be variable in accordance with inclination of the bicycle or the like and may be larger as the inclination of an upslope is larger. In a case where backward movement of the bicycle is detected, an upslope is assumed to be steeper as the output of the electric motor 17 immediately before is larger or the vehicle speed immediately before is slower, and thus braking force may be increased. Moreover, braking force may be increased as the acceleration (absolute value) immediately before occurrence of backward movement is larger. The braking device 12 varies braking force based on, for example, at least one value selected from among the inclination of the bicycle, motor output immediately before occurrence of backward movement, the vehicle speed immediately before, and the acceleration immediately before.

The control device 20 may consider two or more of the above-described conditions (1) to (5) but may activate braking in a case where any one of the conditions is met. In the determination of backward movement of the bicycle, for example, acceleration may be used in addition to or in place of the rotational direction of the electric motor 17. In a case where the electric assist bicycle 1 comprises the acceleration sensor 36 and the sensor is set such that a positive value is output during forward movement of the bicycle and a negative value is output during backward movement, backward movement of the bicycle can be determined based on detection of a negative component.

For example, in a case where reverse rotation of the electric motor 17 is detected in the push-walking free mode, the control device 20 activates braking on a condition (1) in which a predetermined time or shorter has elapsed after the operation signal from the push-walking operation unit 41 stops. The predetermined time is not particularly limited but is one second as an example. The control device 20 activates braking in a case where the braking condition (second braking condition) is met within the predetermined time after an operation of the push-walking operation unit 41 ends, in other words, in a case where the operation mode immediately before is the push-walking drive mode when backward movement of the bicycle has occurred.

With the above-described condition (1) taken into consideration, for example, it is possible to quickly prevent backward movement of the bicycle that may occur when a finger accidentally slips off the push-walking operation unit 41. When the user intentionally moves the bicycle backward, the bicycle can be immediately moved backward in a case where the operation mode immediately before is not the push-walking drive mode. In a case where the operation mode immediately before is the push-walking drive mode but the predetermined time has elapsed after an operation of the push-walking operation unit 41 ends, braking is not activated and thus the bicycle can be easily moved backward.

In a case where reverse rotation of the electric motor 17 is detected in the push-walking free mode, the control device 20 may activate braking on a condition (2) in which the bicycle is climbing a slope. In other words, braking is not activated in a case where the electric assist bicycle 1 is positioned on flat ground or a downslope. The control device 20 can determine whether the bicycle is climbing a slope or the inclination degree of the upslope based on, for example, detection information from the inclination sensor 34. Alternatively, the control device 20 can determine whether the bicycle is climbing a slope based on the position information of the bicycle acquired by the position information receiver 38.

Since backward movement of the bicycle during slope climbing is highly likely to be backward movement unintended by the user, the control device 20 activates braking and transitions to the push-walking stay mode when the above-described condition (2) is met in a case where reverse rotation of the electric motor 17 is detected. Note that, in a case where backward movement of the bicycle has occurred, the control device 20 may recognize slope climbing based on the state of the bicycle immediately before. The state of the bicycle immediately before may be determined based on one piece of information from the bicycle state detection unit 14 or may be compositely determined based on two or more pieces of information.

In a case where reverse rotation of the electric motor 17 is detected in the push-walking free mode, the control device 20 may activate braking on a condition (3) in which the output level of the electric motor 17 immediately before is greater than or equal to a predetermined value. The control device 20 calculates the output level of the electric motor 17 based on, for example, a current value measured by the current sensor 35 and compares the output level immediately before reverse rotation of the electric motor 17 occurs with a predetermined value (threshold value). The output level of the electric motor 17 depends on the amount of current supplied to the electric motor 17, and thus the current value measured by the current sensor 35 may be directly used as the output level and compared with a current value set as the predetermined value.

In a case where the output level of the electric motor 17 immediately before backward movement of the electric assist bicycle 1 occurs is high, the operation mode immediately before is highly likely to be the push-walking drive mode. Thus, with the above-described condition (3) taken into consideration, for example, it is possible to quickly prevent backward movement of the bicycle that occurs in a case where a finger accidentally slips off the push-walking operation unit 41. The phrase “immediately before” means a predetermined time before backward movement of the bicycle occurs. For example, in the cases of (3) and (4), the phrase means immediately before a finger slips off the push-walking operation unit 41, in other words, immediately before the operation signal from the push-walking operation unit 41 stops (immediately before transition is made from the push-walking drive mode to the push-walking free mode), and in the case of (5), the phrase means immediately before backward movement of the bicycle (reverse rotation of the electric motor 17) is detected in the push-walking free mode.

In a case where reverse rotation of the electric motor 17 is detected in the push-walking free mode, the control device 20 may activate braking on a condition (4) in which the vehicle speed immediately before is a predetermined value (predetermined vehicle speed). The control device 20 acquires the vehicle speed measured by, for example, the vehicle speed sensor 32 and compares the vehicle speed with the predetermined value. Note that this condition requires that the vehicle speed immediately before backward movement of the bicycle occurs does not include 0 km/h and the vehicle speed is less than or equal to the predetermined value in a case where the vehicle speed is detected. In this case, push-walking with the bicycle is highly likely to be performed immediately before backward movement. In other words, braking is activated on a condition where push-walking is performed immediately before backward movement of the bicycle occurs.

In a case where reverse rotation of the electric motor 17 is detected in the push-walking free mode, the control device 20 may activate braking upon a condition (5) where the acceleration immediately before is a predetermined value (predetermined acceleration). The control device 20 acquires the acceleration measured by, for example, the acceleration sensor 36 and compares the acceleration with a predetermined value. In this condition, the acceleration immediately before backward movement of the bicycle occurs may be a positive value or a negative value. For example, the predetermined value may be set to 0 km/h² and braking may be activated in a case where the acceleration is negative.

The control device 20 may continue braking force application for a predetermined time or longer. Specifically, once executed, the push-walking stay mode is maintained for the predetermined time or longer. The predetermined time is preferably set to a short time as long as the effect of preventing backward movement of the bicycle is obtained. In this case, the notification device notifies of the predetermined time for which the push-walking stay mode is to be continued. As a specific example, the remaining time of the push-walking stay mode is displayed on the monitor of the switch unit 40.

The control device 20 stops braking force application in a case where a predetermined braking deactivation condition is met in the push-walking stay mode. The braking deactivation condition may be elapse of a predetermined time since braking force application. The control device 20 stops braking force application, for example, in a case where the above-described predetermined time for which the push-walking stay mode is continued has elapsed. In this case, the push-walking stay mode is automatically deactivated and thus no deactivation operation by the user is necessary.

The control device 20 may transition the operation mode of the bicycle from the push-walking stay mode to the push-walking free mode in a case where at least one condition selected from among a condition (i) where the braking device 12 (electric motor 17) has been stopped for a predetermined time, a condition (ii) where the vehicle speed has exceeded a predetermined value, a condition (iii) where the acceleration has exceeded a predetermined value, and a condition (iv) where the bicycle is positioned on flat ground or a downslope is met. The control device 20 may consider two or more of the above-described conditions (1) to (iv) but may deactivate braking in a case where any one of the conditions is met.

The control device 20 may determine that a deactivation condition is met and deactivate braking in a case (i) where the electric motor 17 is stopped for a predetermined time. The control device 20 can determine the state of the electric motor 17 based on the rotation speed of the electric motor 17 measured by the rotation sensor 33. In a case where the stopped state of the electric motor 17 continues for the predetermined time in the push-walking stay mode, braking force to prevent backward movement no longer needs to be applied, and thus the push-walking stay mode is preferably deactivated. The predetermined time is not particularly limited but may be set to a time longer than the predetermined time in the above-described (1) case.

The control device 20 may determine that the deactivation condition is met and deactivate braking in a case (ii) where the vehicle speed has exceeded a predetermined value. Alternatively, the control device 20 may deactivate braking on a condition (iii) where the acceleration has exceeded a predetermined value in the push-walking stay mode. In any case, transition is made from the push-walking stay mode to the push-walking free mode when the bicycle has moved forward against braking force of braking, in other words, when the user has performed push-walking. In a case where the user applies force to move the bicycle forward, braking force to prevent backward movement does not need to be maintained, and thus braking is preferably deactivated to achieve smooth push-walking.

The control device 20 may determine that the deactivation condition is met and deactivate braking in a case where the electric assist bicycle 1 is positioned on flat ground or a downslope. The control device 20 can determine the position of the bicycle based on, for example, the position information of the bicycle acquired by the position information receiver 38. For example, the electric assist bicycle 1 is positioned on an upslope when braking is activated but thereafter is assumed to move to flat ground or a downslope. In this case, braking force to prevent backward movement does not need to be maintained, and thus braking is preferably deactivated.

The control device 20 may determine that the deactivation condition is met, deactivate braking, and transition the operation mode of the bicycle from the push-walking stay mode to the push-walking drive mode in a case where the push-walking operation unit 41 is operated. Specifically, when having received the operation signal from the push-walking operation unit 41 in the push-walking stay mode, the control device 20 generates auxiliary power from the electric motor 17 and transitions to the push-walking drive mode without going through the push-walking free mode. In this case, when a finger has accidentally slipped off the push-walking operation unit 41 during push-walking and the bicycle has moved backward, it is possible to smoothly return to the push-walking drive mode by operating the push-walking operation unit 41 again.

The control device 20 may stop braking force application in a case where the temperature of the electric motor 17 detected by the temperature sensor 37 has exceeded a predetermined threshold value. Specifically, the temperature of the electric motor 17 is considered as the braking deactivation condition. It is assumed that the electric motor 17 enters an overheated state when braking force is generated by using the motor, and in such a case, braking force application is preferably stopped from the perspective of device protection or the like. Note that, for example, the temperature of the drive circuit 18, the temperature of the battery 10, or temperature indirectly indicating these temperatures may be considered in place of or in addition to the temperature of the electric motor 17.

The electric assist bicycle 1 typically comprises a battery state detection unit configured to detect the state of the battery 10. The battery state detection unit is, for example, a voltage sensor configured to detect the voltage of the battery 10. The control device 20 calculates the charge level (remaining amount) of the battery 10 based on the voltage of the battery 10 measured by the voltage sensor, for example. The control device 20 may be configured to select whether to use regenerative braking in accordance with the charge level of the battery 10 as described above. Specifically, in the push-walking stay mode, the battery 10 is charged with electric power generated by using short-circuit braking in a case where the charge level of the battery 10 exceeds a predetermined threshold value or by using regenerative braking in a case where the charge level is less than or equal to the threshold value.

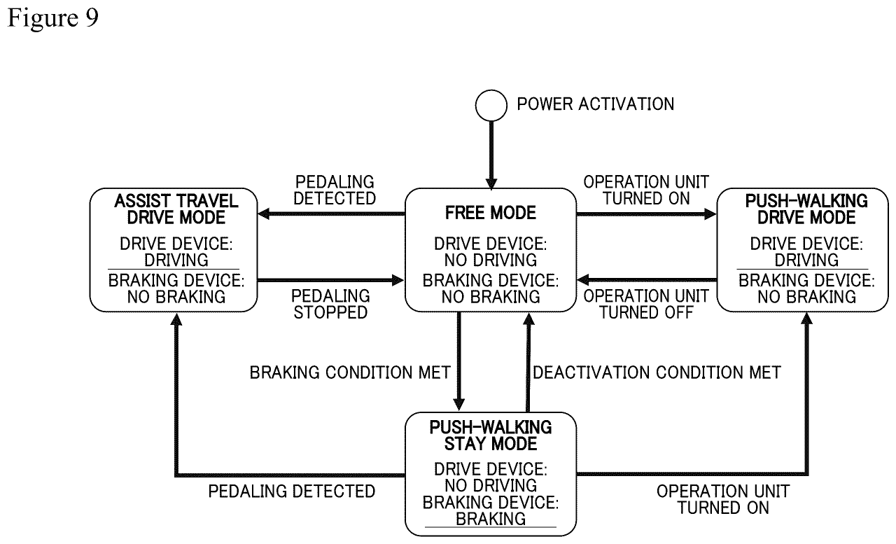

FIG. 9 is a diagram illustrating a modification of state transition (operation mode transition).

As illustrated in FIG. 9, the control device 20 may transition the operation mode of the bicycle to the push-walking mode without determining riding or non-riding. In the example illustrated in FIG. 9, transition is made from the free mode, in which the drive device 11 and the braking device 12 are not driven, to the push-walking drive mode based on the operation signal from the push-walking operation unit 41, and transition is made to the assist travel drive mode in a case where pedaling is detected. In addition, transition is made to the push-walking stay mode in a case where backward movement of the electric assist bicycle 1 has occurred, and transition is directly made to the assist travel drive mode in a case where pedaling is detected in the push-walking stay mode.

In the example illustrated in FIG. 9, even in a riding state (first state), auxiliary power can be output through an operation of the push-walking operation unit 41, and the braking device 12 is automatically activated when backward movement that is unintended by the user occurs. In this case, the electric assist bicycle 1 does not necessarily need to include the switching unit included in the riding device and the riding device state detection unit 13.

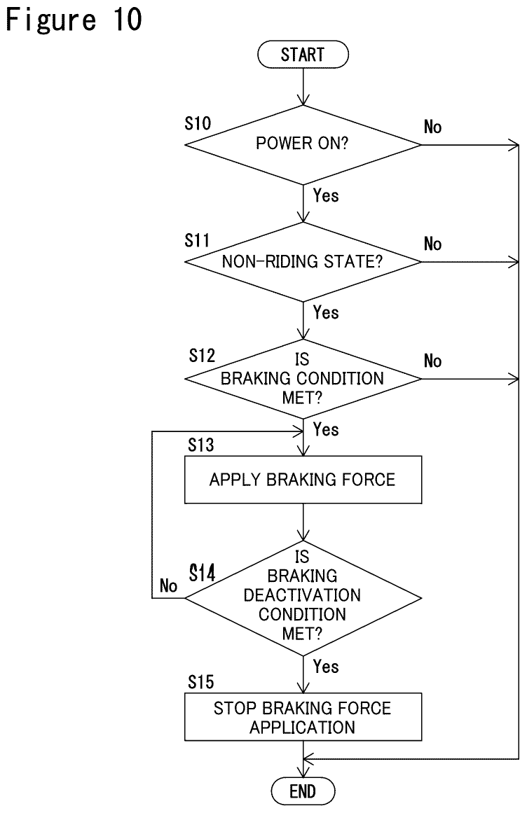

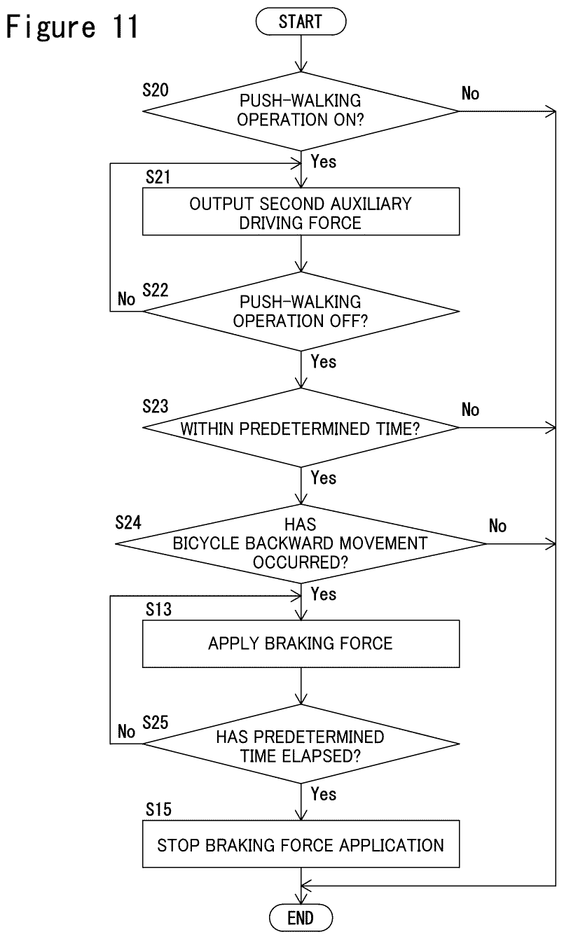

FIG. 10 is a flowchart illustrating an example of a basic control procedure related to the push-walking mode. FIG. 11 is a flowchart illustrating a specific example of the control procedure.

As illustrated in FIG. 10, in a case where the power switch is turned on and the control device 20 is activated (Yes at step S10), the operation mode of the electric assist bicycle 1 changes to the push-walking mode on a condition where the saddle 5 is in the second state (non-riding state) (Yes at step S11). The state of the saddle 5 is determined based on detection information from the riding device state detection unit 13. In the case of the second state where the seat surface of the saddle 5 faces forward, a detection signal is output from the riding device state detection unit 13 and a non-riding state is determined when the signal is received by the control device 20. Note that, in a case where the saddle 5 is in the first state, the operation mode does not transition to the push-walking mode but transitions to the assist travel mode.

In the push-walking mode, in a case where a predetermined braking condition is met (Yes at step S12), the braking device 12 is activated and braking force is applied to the wheel (step S13). The control device 20 activates braking and transitions the operation mode to the push-walking stay mode in a case where the braking condition is met. In the push-walking stay mode, in a case where a predetermined braking deactivation condition is met (Yes at step S14), the control device 20 deactivates braking and stops braking force application (step S15). Note that the push-walking stay mode is continued until the deactivation condition is met. Details of the braking condition and the deactivation condition are as described above.

In the example illustrated in FIG. 11, backward movement of the bicycle within a predetermined time after an operation of the push-walking operation unit 41 is an example of the braking condition. In addition, elapse of a predetermined time since braking force application is an example of the deactivation condition. In FIG. 11, the same procedure as that illustrated in FIG. 10 is denoted by the same reference sign.

As illustrated in FIG. 11, in the push-walking mode, in a case where the push-walking operation unit 41 is operated (Yes at step S20), the control device 20 activates the electric motor 17 to generate the second auxiliary driving force (step S21). Accordingly, transition is made from the push-walking free mode to the push-walking drive mode. Then, the push-walking drive mode is continued while the operation of the push-walking operation unit 41 is continued and the operation signal is received.

When the operation of the push-walking operation unit 41 has stopped (Yes at step S22), the control device 20 activates braking on a condition where a predetermined time has not elapsed since reception of the operation signal stops (Yes at step S23) and backward movement of the bicycle has occurred (Yes at step S24), and transitions the operation mode to the push-walking stay mode (step S13). In other words, the control device 20 applies braking force in a case where backward movement of the bicycle has occurred within the predetermined time since the operation of the push-walking operation unit 41 ended.

In a case where a predetermined time has elapsed since start of the push-walking stay mode (Yes at step S25), the control device 20 deactivates braking and transitions the operation mode to the push-walking free mode (step S15). In the push-walking stay mode, for example, the remaining time of braking force application is displayed as a countdown on the monitor of the switch unit 40. Then, braking is deactivated when the remaining time reaches zero. In this manner, braking force is maintained for the predetermined time and the remaining time is notified, and thus the user can easily respond by, for example, gripping the brake levers 4b or pushing the push-walking operation unit 41 until braking is deactivated.

According to the electric assist bicycle 1 having the above-described configuration, for example, in a case where a finger accidentally has slipped off the push-walking operation unit 41 during push-walking with the bicycle on an upslope, the braking device 12 is automatically activated and thus backward movement of the bicycle that is unintended by the user can be quickly prevented. For example, in a case where reverse rotation of the electric motor 17 is detected by the rotation sensor 33, the control device 20 determines that backward movement has occurred, activates the braking device 12, and prevents backward movement of the bicycle. Note that backward movement of the electric assist bicycle 1 may be detected by using another sensor that functions as the bicycle state detection unit 14.

The control device 20 can determine whether to transition to the push-walking stay mode and apply braking force based on a state immediately before backward movement of the electric assist bicycle 1 occurs. Accordingly, it is possible to allow backward movement intentionally performed by the user and selectively prevent only backward movement that is unintended by the user. For example, transition is made to the push-walking stay mode only in a case where a predetermined time or shorter has elapsed since the operation signal from the push-walking operation unit 41 stopped, and in this manner, braking force is not applied when the bicycle is moved backward at the time of bicycle parking or the like. Accordingly, usability improves.

Note that, in addition to the above-described modification, various kinds of design changes may be made to the above-described embodiment without departing from the scope of the objectives of the present invention. For example, the electric assist bicycle of the present invention may include an operation unit such as a throttle and have a self-propelling mode in which motor output is controlled based on an operation of the operation unit. In addition, a sensor capable of detecting push-walking with the bicycle may be provided. The sensor is installed on, for example, a grip of the handlebar and measures a load acting on the grip during push-walking, or distribution of the load. In this case, push-walking is detected based on the load acting on the grip or its distribution. Moreover, a sensor configured to detect a load acting on the saddle may be used in place of the switching unit 152 to determine riding or non-riding. In the above-described embodiment, the state of the saddle 5 is switched between the first state in which the saddle 5 is rideable and the second state in which the saddle 5 is not rideable, but the state of parts of the riding device other than the saddle 5, such as the pedals and the handlebar, may be switched between first and second states.

### REFERENCE SIGNS LIST

1 Electric assist bicycle, 2 Frame, 2a Head pipe, 2b Front fork, 2c Down pipe, 2d Seat pipe, 2e Chain stay, 2f Seat stay, 3a Front wheel, 3b Rear wheel, 4 Handlebar, 4a Grip, 4b Brake lever, 4c Stem, 4d Steering column, 5 Saddle, 6 Crank arm, 7 Pedal, 8 Chain, 9 Headlamp, 10 Battery, 11 Drive device, 12 Braking device, 13 Riding device state detection unit, 14 Bicycle state detection unit, 16 Motor unit, 17 Motor, 18 Drive circuit, 20 Control device, 21 Processor, 22 Memory, 23 First processing unit, 24 Second processing unit, 25 Third processing unit, 31 Torque sensor, 32 Vehicle speed sensor, 33 Rotation sensor, 34 Inclination sensor, 35 Current sensor, 36 Acceleration sensor, 37 Temperature sensor, 38 Position information receiver, 40 Switch unit, 41 Push-walking operation unit, 152 Switching unit, 153 Base section, 154 Lever section, 155 Pushing section, 157 Base part, 158 Movable base, 1541 Griping unit, 1542 Claw section, 1571 Body part, 1574 Projecting portion, 1578, 1581 Slit, 1579 First support, 1589 Second support

1. An electric assist bicycle comprising a riding device and an electric motor, the electric assist bicycle further comprising:
a control unit configured to execute, in a switching manner, a first mode in which first auxiliary driving force from the electric motor is added to human driving force based on pedal stepping force for traveling, and a second mode in which second auxiliary driving force from the electric motor is added to pushing force on a vehicle body for push-walking or the second auxiliary driving force is added for self-propelling the electric assist bicycle;
a riding device state detection unit configured to detect a state of the riding device, the state including a first state in which the riding device is rideable and a second state in which the riding device is not rideable;
a second mode operation unit configured to transmit a signal for executing the second mode to the control unit; and
a braking device configured to apply braking force to prevent backward movement of the electric assist bicycle in a case where a braking condition is met, wherein
the control unit executes the second mode in a case where the second mode operation unit is operated in the second state, and
the braking condition includes at least one of a first braking condition where an upslope is detected in the second state and a second braking condition where backward movement of the electric assist bicycle is detected in the second state.

2. An electric assist bicycle comprising an electric motor, the electric assist bicycle further comprising:
a control unit configured to execute, in a switching manner, a first mode in which first auxiliary driving force from the electric motor is added to human driving force based on pedal stepping force for traveling and a second mode in which second auxiliary driving force from the electric motor is added to pushing force on a vehicle body for push-walking or the second auxiliary driving force is added for self-propelling the electric assist bicycle;
a second mode operation unit configured to transmit a signal for executing the second mode to the control unit; and
a braking device configured to apply braking force to prevent backward movement of the electric assist bicycle in a case where a braking condition is met, wherein
the braking condition includes at least one of a first braking condition where an upslope is detected after an operation of the second mode operation unit ends and a second braking condition where backward movement of the electric assist bicycle is detected after an operation of the second mode operation unit ends.

3. An electric assist bicycle comprising an electric motor, the electric assist bicycle further comprising:
a control unit configured to execute an electric assist mode in which auxiliary driving force from the electric motor is added to human driving force based on pedal stepping force for traveling; and
a braking device configured to apply braking force to prevent backward movement of the electric assist bicycle in a case where a braking condition is met, wherein
the braking condition includes at least one of a first braking condition where an upslope is detected in a case of stopping after traveling at or above a predetermined speed, and a second braking condition where backward movement of the electric assist bicycle is detected within a predetermined time in a case of stopping after traveling at or above a predetermined speed.

4. The electric assist bicycle according to claim 1, wherein
the braking device applies the braking force in a case where the braking condition is met after an operation of the second mode operation unit ends.

5. The electric assist bicycle according to claim 1, wherein
the braking device applies the braking force in a case where the second braking condition is met within a predetermined time after an operation of the second mode operation unit ends.

6. The electric assist bicycle according to claim 1, wherein
the braking device applies braking force in a case where the braking condition is met after traveling at or above a predetermined speed in the second mode.

7. The electric assist bicycle according to claim 1, further comprising
an inclination sensing device, wherein
the braking device applies the braking force in a case where an upward inclination degree greater than or equal to a predetermined degree is sensed by the inclination sensing device.

8. The electric assist bicycle according to claim 1, wherein
the braking device continues application of the braking force for a predetermined time or longer.

9. The electric assist bicycle according to claim 8, further comprising
a notification device, wherein
the notification device notifies that the braking force is applied.

10. The electric assist bicycle according to claim 9, wherein
the notification device notifies of the predetermined time.

11. The electric assist bicycle according to claim 1, wherein
the control unit determines that the braking condition is met in a case where reverse rotation of the electric motor is detected.

12. The electric assist bicycle according to claim 1, wherein
the control unit determines that the second braking condition is met in a case where reverse rotation of the electric motor is detected and at least one condition, selected from among a condition where a predetermined time or shorter has passed since an operation of the second mode operation unit ended, a condition where the electric assist bicycle is climbing a slope, a condition where an output level of the electric motor immediately before is greater than or equal to a predetermined value, a condition where vehicle speed immediately before is less than or equal to a predetermined value, and a condition where acceleration immediately before is less than or equal to a predetermined value, is met.

13. The electric assist bicycle according to claim 1- or 2, wherein
the second mode includes a drive mode in which the second auxiliary driving force is applied, a stay mode in which the braking force is applied by the braking device, and a free mode in which the second auxiliary driving force and the braking force are not applied, and
the control unit transitions the drive mode to the stay mode via the free mode.

14. The electric assist bicycle according to claim 13, wherein
the control unit transitions the free mode to the drive mode and the stay mode on a condition where the riding device is in the second state.

15. The electric assist bicycle according to claim 13, wherein
the control unit transitions the stay mode to the drive mode in a case where the second mode operation unit is operated in the stay mode.

16. The electric assist bicycle according to claim 1, wherein
the braking device stops application of the braking force in a case where at least one condition, selected from among a condition where the electric motor has been stopped for a predetermined time, a condition where vehicle speed has exceeded a predetermined value, a condition where acceleration has exceeded a predetermined value, and a condition where the electric assist bicycle is positioned on flat ground or a downslope, is met.
